(19) United States
(12) Patent Application Publication
(10) Pub. No.: US 2008/0111782 A1
(43) Pub. Date: May 15, 2008

(54) LIQUID CRYSTAL DISPLAY DEVICE AND METHOD FOR DRIVING THE SAME

(75) Inventors: Dong-Lyoul SHIN, Suwon-si (KR); Jae-Jin CHOI, Seoul (KR); Hyo-Suck CHUN, Suwon-si (KR); Yong-Seok KWAK, Seongnam-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/930,545

(22) Filed: Oct. 31, 2007

(30) Foreign Application Priority Data
Nov. 11, 2006 (KR) 10-2006-0111344

(51) Int. Cl. G09G 3/36

(52) U.S. Cl. 345/99; 345/102; 349/61

(57) ABSTRACT

A liquid crystal display (“LCD”) device includes an LCD panel, an error memory which stores error values obtained by comparing measured values for characteristics of an image displayed on the LCD panel with a reference value suitable for the LCD panel, an image processor which processes a signal supplied from a system main body in consideration of the error values, a timing controller which receives the signal processed in the image processor and generates a driving signal, and a driver which supplies the driving signal to the LCD panel.

This application claims priority to Korean Patent Application No. 2006-0111344 filed on Nov. 11, 2006 and all the benefits accruing therefrom under 35 U.S.C. §119, and the contents of which in its entirety are herein incorporated by reference.

### BACKGROUND OF THE INVENTION

1. Field of the Invention

The present invention relates to a liquid crystal display (“LCD”) device and method for driving the LCD device, and more particularly, to an LCD device and a method for driving the LCD device capable of improving display quality of an LCD panel.

2. Description of the Related Art

Recently, liquid crystal display (“LCD”) devices have increasingly become important as one of various display devices as a modern society becomes informational society. Cathode ray tubes (“CRTs”) which have been most widely used have many merits in terms of performance and price, but have many drawbacks in terms of compactness or portability. On the other hand, the LCD devices are high in price, but have been increasingly used in a broad range of applications because they are compact, lightweight, thin, slim and require low power consumption. The LCD devices apply an electric field to a liquid crystal material having dielectric anisotropy and interposed between two substrates, and display a desired image by adjusting an amount of light transmitting through the substrates by the strength of an electric field.

Since an LCD panel of the LCD device is a non-emitting element which may not emit light by itself, an LCD device requires a backlight unit which provides the LCD panel with light.

The backlight unit includes a light emitting diode (“LED”) as a light source, a circuit board supplying a power to the LED, and a light guide plate increasing efficiency of light emitted from the LED. Before implementing the LCD panel using the backlight unit, a light source is tested. After testing whether or not luminance of light emitted from the light source is uniform, the light source which does not have uniform light luminance is removed, thus increasing material costs. Further, if light supplied from the backlight unit is not constant, then an image is not uniformly displayed on the LCD panel.

### BRIEF SUMMARY OF THE INVENTION

The present invention provides an LCD device, and a method for driving the same, capable of improving display quality of an LCD panel.

In exemplary embodiments of the present invention, an LCD device includes an LCD panel, an error memory which stores error values obtained by comparing measured values for characteristics of an image displayed on the LCD panel with a reference value suitable for the LCD, an image processor which processes a signal supplied from a system main body in consideration of the error values, a timing controller which receives the signal processed in the image processor and generates a driving signal, and a driver which supplies the driving signal to the LCD panel.

The characteristics of the image may include at least one of luminance and color of the image.

The LCD device may further include a point light source which supplies light to the LCD panel.

The measured values may be obtained by dividing the LCD panel into N areas in a row direction and M areas in a column direction and by measuring the characteristics of the image at each area.

When the characteristics of the image include luminance, the reference value of the luminance may be an average value of the measured values of the luminance measured at each area. The error values may be values which subtract the reference value from the measured values higher than the reference value at each area, and the image processor may process the signal supplied from the system main body so as to have a substantially same value as the reference value considering the error values with respect to areas having the measured values higher than the reference value.

Also when the characteristics of the image include luminance, the reference value of the luminance may be a lowest value among the measured values of the luminance measured at each area. The error values may be values which subtract the reference value from the measured values at each area, and the image processor may process the signal supplied from the system main body so as to have a substantially same value as the reference value considering the error values.

When the characteristics of the image include color, the reference value of the color may be based on a chromaticity coordinates system.

The LCD device may further include a measurer which measures the characteristics of the image displayed on the LCD panel. The LCD device may further include a calculator calculating the error values by comparing the measured values with the reference value.

In other exemplary embodiments of the present invention, a method for driving an LCD device includes storing an error value obtained by comparing measured values measuring characteristics of an image displayed on an LCD panel with a reference value in an error memory, processing a signal supplied from a system main body considering the error values supplied from the error memory, generating a driving signal by receiving the processed signal, and supplying the driving signal to the LCD panel.

The method may further include dividing the LCD panel into N areas in a row direction and M areas in a column direction and measuring the characteristics of the image at each area.

The method may further include calculating the error value by comparing the measured values of the characteristics of the image displayed on the LCD panel with the reference value.

The method may further include measuring the characteristics of the image displayed on the LCD panel at each area, calculating the error value for the characteristics at each area, converting the error value into a corresponding digital value, and storing the converted digital value in the error memory.

In still other exemplary embodiments of the present invention, a method of improving uniformity of an LCD panel may include measuring characteristics of an image displayed on areas of the LCD panel, calculating an error value for the characteristics at each area by comparing measured values with a reference value suitable for the LCD panel, converting the error value into a corresponding digital value, and generating signals for the LCD panel in consideration of the error value.

### BRIEF DESCRIPTION OF THE DRAWINGS

The above and other features and advantages of the present invention will become more apparent by describing exemplary embodiments thereof with reference to the accompanying drawings, in which:

FIG. 1 is a block diagram showing an exemplary main body and an exemplary LCD device according to an exemplary embodiment of the present invention;

FIG. 2 is a graphical view showing an exemplary measurer measuring characteristics of an exemplary LCD panel at a position spaced apart therefrom by a constant distance according to an exemplary embodiment of the present invention;

FIG. 3A is a flow chart showing an exemplary method for driving the exemplary LCD device for uniformity of luminance and/or color according to an exemplary embodiment of the present invention;

FIG. 3B is a block diagram showing an exemplary method for driving the exemplary LCD device for uniformity of luminance and/or color according to an exemplary embodiment of the present invention;

FIG. 4 is a graph showing an exemplary luminance error value at each area;

FIG. 5 is a graphical view showing an exemplary error value tested at each area as a gamma curve; and

FIG. 6 is a diagram showing chromaticity coordinates which obtain exemplary color error values using a reference value and a measured value for a color.

### DETAILED DESCRIPTION OF THE INVENTION

The invention now will be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below. The device may be otherwise oriented (rotated 90 degrees or at other orientations) and the spatially relative descriptors used herein interpreted accordingly.

Hereinafter, exemplary embodiments of the present invention will now be described in detail with reference to the accompanying drawings.

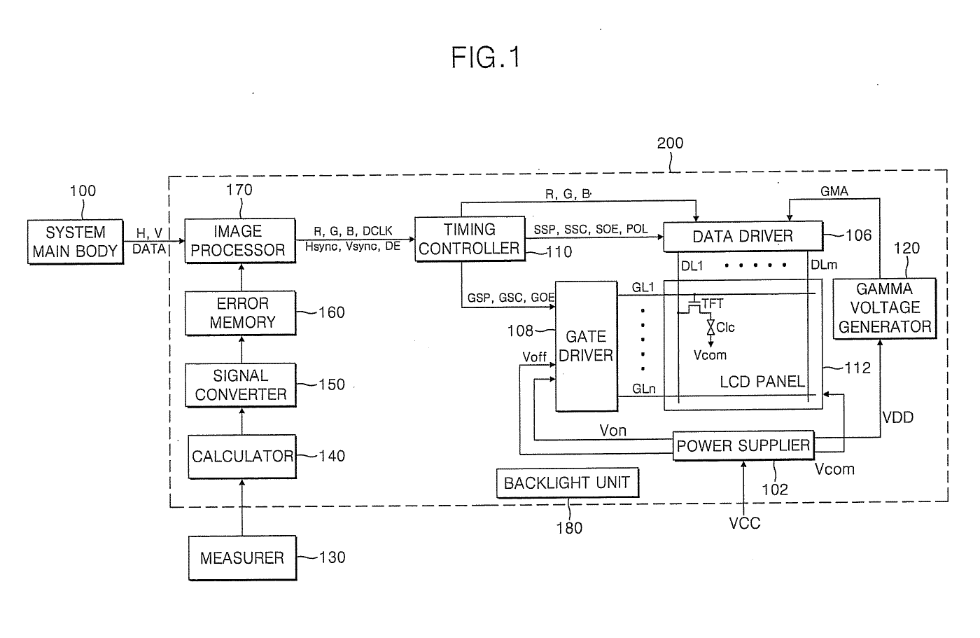

FIG. 1 is a block diagram showing an exemplary main body and an exemplary liquid crystal display (“LCD”) device according to an exemplary embodiment of the present invention.

An LCD device 200 shown in FIG. 1 includes an LCD panel 112 having a pixel matrix, a measurer 130 measuring characteristics of the LCD panel 112, such as luminance and/or color, a calculator 140 calculating an error value for the luminance and/or color at each area of the LCD panel 112, a signal converter 150 converting the error value for the luminance and/or color into a digital signal value, an error memory 160 storing a digital signal value for the luminance and color and supplying the digital signal value to the timing controller 110, a gate driver 108 driving gate lines GL1 to GLn of the LCD panel 112, a data driver 106 driving data lines DL1 to DLm of the LCD panel 112, a power supplier 102 supplying a gate-on voltage Von, a gate-off voltage Voff, a common voltage Vcom, and a gamma voltage VDD necessary for driving the LCD device 200, and the timing controller 110 controlling driving timings of the gate driver 108 and the data driver 106. The LCD device 200 further includes an image processor 170 processing synchronization signals supplied from a system main body 100 in consideration of the error value which is stored in the error memory 160, and a backlight unit 180 supplying a predetermined light to the LCD panel 112. A light source of the backlight unit 180 may be a point light source, for example, a light emitting diode (“LED”).

The measurer 130 and the calculator 140 may be included in the LCD device 200 or provided outside the LCD device 200.

The LCD panel 112 includes a pixel matrix with pixels formed at respective pixel areas. In one exemplary embodiment, the pixel areas may be defined by the gate lines GL1 to GLn and the data lines DL1 to DLm. Each pixel includes a liquid crystal cell Clc, such as a liquid crystal capacitor, adjusting an amount of light transmittance and a thin film transistor (“TFT”) driving the liquid crystal cell Clc.

In a TFT connected to a first gate line GL1 and a first data line DL1, the TFT is turned on when the gate-on voltage Von is supplied to the gate line GL1 and supplies the liquid crystal cell Clc with a pixel signal delivered from the data line DL1. The TFT is turned off when the gate-off voltage Voff is supplied to the gate line GL1 and maintains the pixel signal charged in the liquid crystal cell Clc constant.

The liquid crystal cell Clc includes a common electrode and a pixel electrode connected to the TFT with liquid crystal disposed therebetween. The liquid crystal cell Clc further includes a storage capacitor (not shown) so that the charged pixel signal is stably maintained until the next pixel signal is charged. The liquid crystal cell Clc controls light transmittance by varying an arrangement of the liquid crystal with dielectric anisotropy according to the pixel signal charged through the TFT, thus implementing a gray level. The liquid crystal cell Clc may be equivalently expressed as a capacitor.

The gate driver 108 shifts a gate start pulse GSP supplied from the timing controller 110 according to a gate shift clock GSC, also from the timing controller 110, and sequentially provides the gate lines GL1 to GLn with a scan pulse of the gate-on voltage Von supplied from the power supplier 102. The gate driver 108 provides the gate lines GL1 to GLn with the gate-off voltage Voff supplied from the power supplier 102 while the scan pulse of the gate-on voltage Von is not supplied to the gate lines GL1 to GLn.

Further, the gate driver 108 controls a pulse width of the scan pulse according to a gate output enable signal GOE supplied from the timing controller 110.

The data driver 106 shifts a source start pulse SSP supplied from the timing controller 110 according to a source shift clock SSC, also from the timing controller 110, and generates a sampling signal. The data driver 106 latches pixel data R, G, and B input by the source shift clock SSC according to the sampling signal, and then generates the latched data line by line in response to a source output enable signal SOE from the timing controller 110. The data driver 106 converts the pixel data R, G, and B supplied from the timing controller 110 into an analog pixel signal corresponding to a gray level by using a gamma voltage GMA supplied from a gamma voltage generator 120 and supplies the data signal to data lines DL1 to DLm. The data driver 106 determines a polarity of the pixel signal in response to a polarity control signal POL from the timing controller 110 when converting the pixel data into the pixel signal. Furthermore, the data driver 106 determines a period during which the pixel signal is supplied to the data lines DL1 to DLm in response to the source output enable signal SOE.

The power supplier 102 receives a driving voltage VCC from the outside and supplies the driving voltage VCC to the timing controller 110, the data driver 106, and the gate driver 108. The power supplier 102 generates the gate-on voltage Von and the gate-off voltage Voff to be supplied to the gate driver 108 and generates the common voltage Vcom to be supplied to the LCD panel 112.

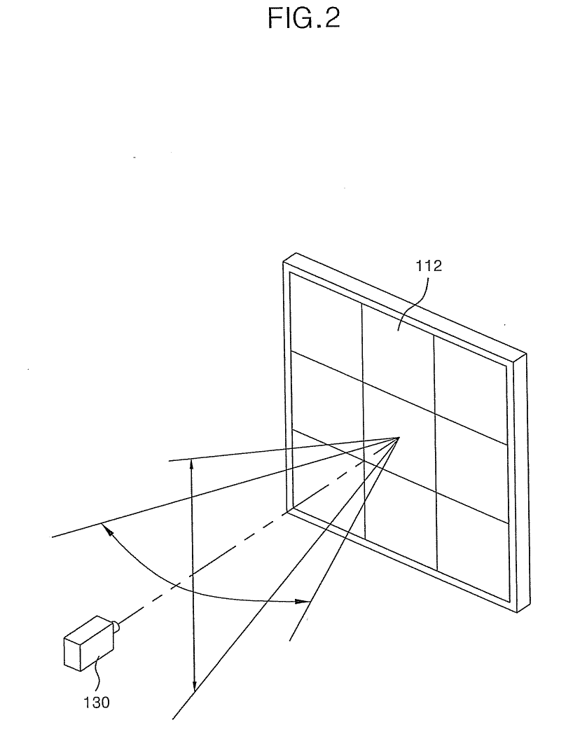

As shown in FIG. 2, the measurer 130 is positioned to be spaced apart from the LCD panel 112 by a constant distance and measures the luminance and/or color of an image displayed on the LCD panel 112. The measurer 130 supplies the calculator 140 with a measured value for the luminance and/or color of an image displayed on the LCD panel 112. For measurement, the LCD panel 112 may be divided into N×M areas, for example, as in the illustrated embodiment, three areas in a row direction and three areas in a column direction. While 3×3 areas are illustrated for exemplary purposes, it should be understood that the measurer 130 may measure the luminance and/or color by dividing the area of the LCD panel 112 into any number of areas according to user's demand. Hereinafter, the LCD panel 112 having first to ninth areas will be described as an example.

The calculator 140 calculates an error value by comparing a reference value for the luminance and color suitable for the LCD panel 112 with a measured value for the luminance and/or color at each area of the first to ninth areas, as measured by the measurer 130, and then supplies the error value calculated by the calculator 140 to the signal converter 150. Herein, as will be further described below, the reference value for the luminance is a lowest value of luminance values at the areas, or an average value of luminance values at the areas. Further, the reference value for the color may be based on chromaticity coordinates.

If the lowest luminance value at the first to ninth areas is the reference value, then values which reduce the luminance values measured at the first to ninth areas by the degree brighter than the reference value become luminance error values P11 to P33 of the corresponding areas. Likewise, if the average value of luminance values at the first to ninth areas is the reference value, then values which reduce the measured luminance values by the degree brighter than the average value become the error values of the corresponding areas.

The signal converter 150 converts the luminance error values P11 to P33 and color error values C11 to C33 at the first to ninth areas as calculated by the calculator 140 into signals recognized by the timing controller 110 and stores the signals in the error memory 160. For example, the signal converter 150 converts the luminance error values P11 to P33 and color error values C11 to C33 of the first to ninth areas supplied from the calculator 140 as an analog signal form into digital signals S11 to S33.

The error memory 160 stores the digital signals S11 to S33 supplied from the signal converter 150 and then supplies the digital signals S11 to S33 to the image processor 170. The error memory 160 may be an electrically erasable programmable read only memory (“EEPROM”).

The image processor 170 processes a plurality of synchronization signals H, V and DATA input from the system main body 100 according to the digital signals S11 to S33 supplied from the error memory 160, and then supplies the processed synchronization signals, such as a data enable signal DE, a horizontal synchronization signal Hsync, a vertical synchronization signal Vsync, and a dot clock DCLK, to the timing controller 110.

The timing controller 110 generates gate control signals GSP, GSC and GOE and data control signals SSP, SSC, SOE and POL using the synchronization signals input from the image processor 170 and supplies a corresponding control signal to the gate driver 108 and the data driver 106. The synchronization signals input from the image processor 170 may include the data enable signal DE informing a valid data period input from the outside, the horizontal synchronization signal Hsync, the vertical synchronization signal Vsync, and the dot clock DCLK determining a transmitting timing of the pixel data R, G, and B. The timing controller 110 arranges data signals input from the system main body 100 through a connector (not shown) and supplies them to the data driver 106.

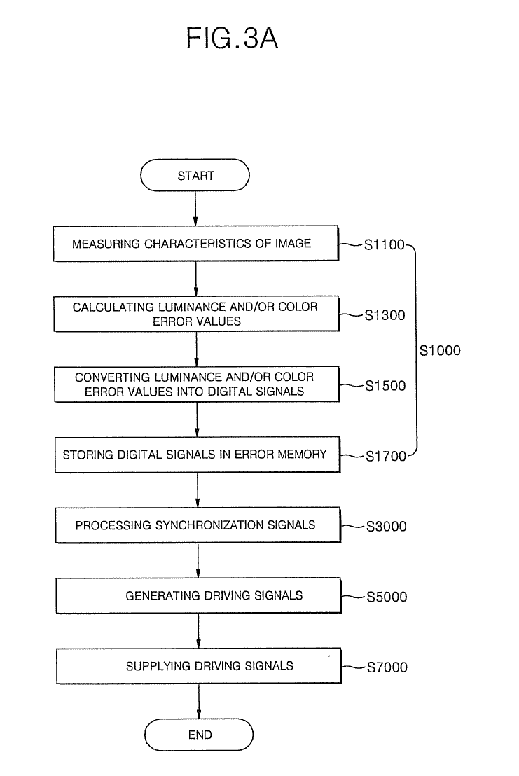

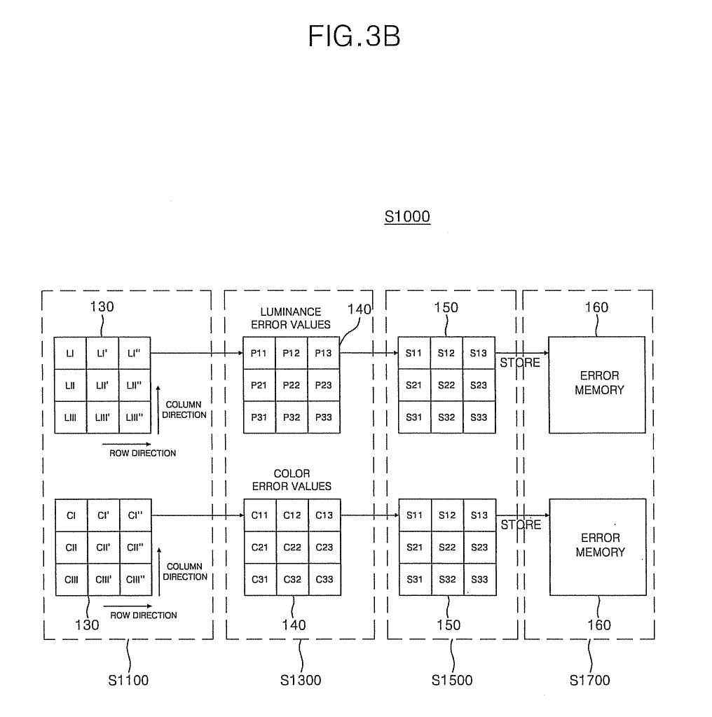

FIG. 3A is a flow chart showing an exemplary method for driving the exemplary LCD device for uniformity of luminance and/or color according to an exemplary embodiment of the present invention. FIG. 3B is a block diagram showing an exemplary method of driving the exemplary LCD device for uniformity of luminance and/or color according to an exemplary embodiment of the present invention.

Referring to FIG. 3A, the error values obtained by comparing the measured values measuring the characteristics of the image display panel 112 with the reference value are stored in the error memory 160 at step S1000, as will be further described below. The plurality of the synchronization signals supplied from the system main body 100 are processed by the image processor 170 in consideration of the error value supplied from the error memory 160 at step S3000. The driving signals based on the processed synchronization signals are generated by the timing controller 110 at step S5000. The generated driving signals are supplied to the data driver 106 and gate driver 108 at step S7000.

The step S1000 further includes measuring the luminance and/or color displayed on the LCD panel 112 at each area (step S1100), such as by using measurer 130, calculating the luminance error values P11 to P33 and the color error values C11 to C33 (step S1300), such as by using calculator 140, converting the error values into corresponding digital values S11 to S33 (step S1500), such as by using signal converter 150, and storing the digital values S11 to S33 in the error memory 160 (step S1700)

Referring to FIG. 3B, the measurer 130 measures the luminance and/or color at each area of the LCD panel 112 at step S1100. The measurer 130 divides the LCD panel 112 into N areas in a row direction and M areas in a column direction, and measures the luminance and/or color at each area. For example, as shown in the illustrated exemplary embodiment, the LCD panel 112 may be divided into first to ninth areas, three areas in the row direction and three areas in the column direction. At this time, measured values for the luminance LI to LIII″ and/or measured values for color CI to CIII″ at the first to ninth areas displayed on the LCD panel 112 are supplied from the measurer 130 to the calculator 140.

In the calculating step S1300, the calculator 140 compares the reference value for the luminance and/or color suitable for the LCD panel 112 with the measured values for the luminance LI to LIII″ and/or the measured values for color CI to CIII″ measured at the first to ninth areas and calculates the luminance error values P11 to P33 and color error values C11 to C33. One exemplary method of calculating the luminance error value at each area includes the calculator 140 calculating the error value by comparing the lowest luminance value with the luminance value at each area. Another exemplary method of calculating the luminance error value includes using the average value for the luminance values at the respective areas and calculating the error value by comparing the average value with the luminance value at each area. Further, a method of calculating the color error value at each area in the calculator 140 includes comparing a color reference value according to chromaticity coordinates with the color value at each area.

A method of calculating the luminance error values P11 to P33 based on the lowest luminance value will be described by way of example.

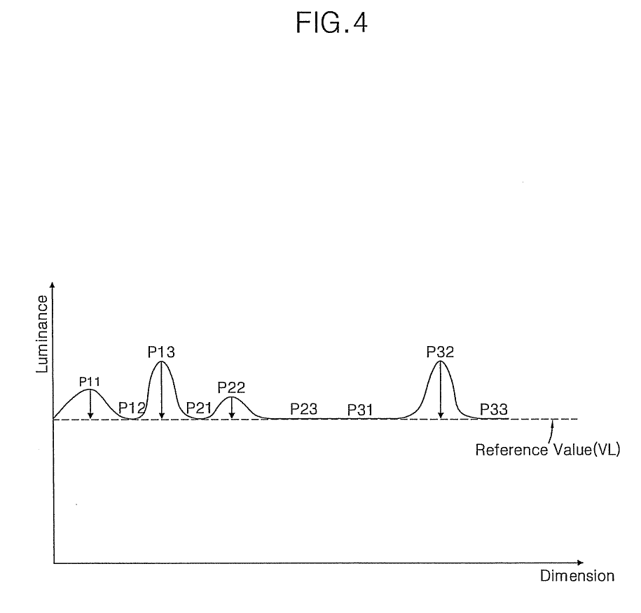

The lowest luminance value among measured values LI to LIII″ at the first to ninth areas is obtained and then the lowest luminance value becomes a reference value VL. Accordingly, the luminance error values P11 to P33 at each area indicate values which are reduced by the degree brighter than the luminance values LI to LIII″ displayed at each area based on the reference value VL. As shown in FIG. 4, when the luminance value LI displayed on the first area is brighter than the reference value VL by P11, the luminance error value of the first area becomes P11. The third area is brighter than the first area. Since the luminance value I″ of the third area is brighter than the reference value VL by P13, the error value of the third area becomes P13. Likewise, the error values of the fifth and eighth areas become P22 and P32, respectively. The luminance values of the second, fourth, sixth, seventh, and ninth areas P12, P21, P23, P31, and P33, respectively, are substantially equal to the reference value VL and the error values of those areas become zero.

In this way, the error values P11 to P33 are increased by the degree brighter than the reference value VL at the first to ninth areas. Accordingly, a luminance difference between the first to ninth areas is removed considering each luminance value of the first to ninth areas, thus becoming a constant reference value.

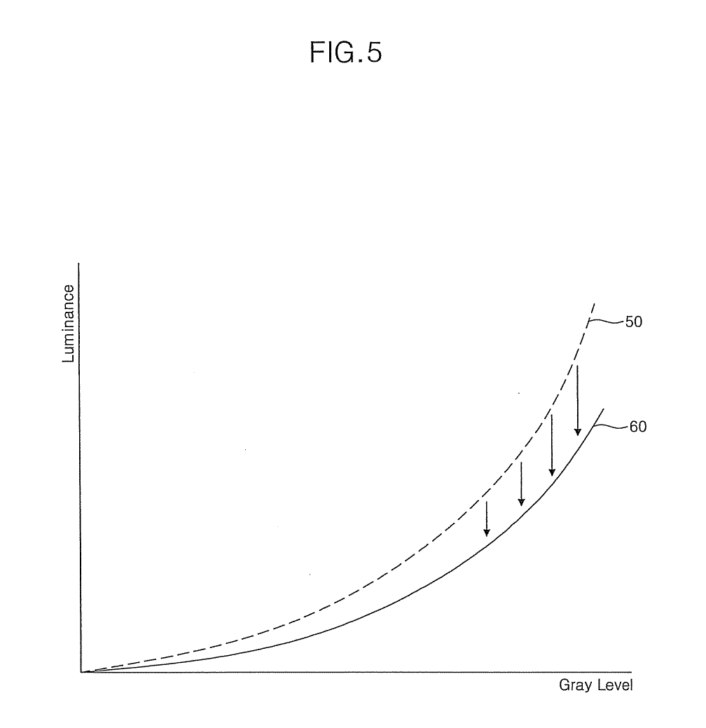

Meanwhile, a first gamma curve 50 shown in FIG. 5 indicates a gamma curve according to the luminance displayed on the first area, a second gamma curve 60 indicates an ideal gamma curve induced from the first gamma curve displayed on the first area in consideration of the luminance error value. Accordingly, a gamma curve according to the luminance displayed at each area is corrected, and thus the luminance at each area is softly displayed. The luminance at the second to ninth areas becomes uniform using the gamma curve in the same way as that of the first area.

As another exemplary embodiment, a method of calculating the error value based on the average of the luminance values LI to LII″ at each area calculates the average luminance value at each area, and then the average value becomes the reference value VL. Accordingly, a value which is reduced by the degree brighter than the average value by comparing the average value with the luminance of each area becomes the error value at a corresponding area.

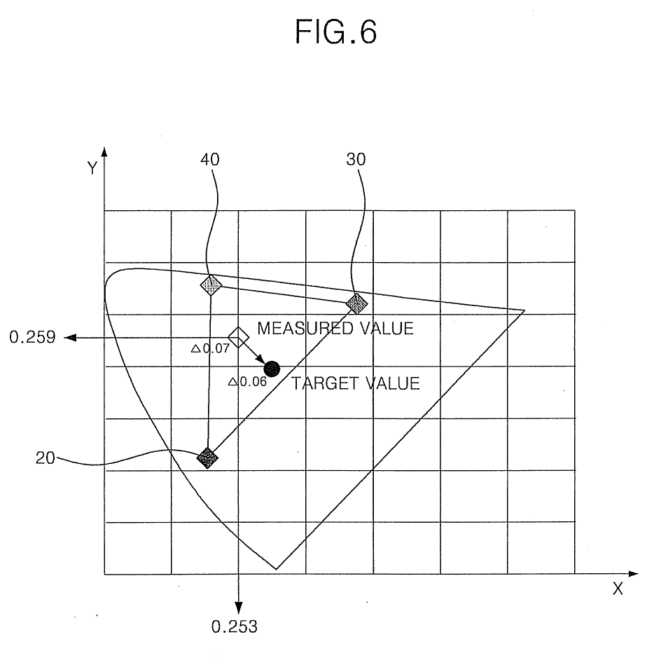

A method of calculating the color error values C11 to C33 using chromaticity coordinates will be described with reference to FIG. 6. The chromaticity coordinates diagram shown in FIG. 6 defines a color standard and represents a range of maximum chromaticity which may find real light stimulus coordinates. Further, three points 30, 40, and 20 displayed within a range of maximum chromaticity represent a range of red, green, and blue which may be displayed on the LCD panel 112.

Referring back to FIG. 3B, the calculator 140 calculates the color error values C11 to C33 by comparing a color reference value for the color suitable for the LCD panel 112 with red, green, and blue values CI to CIII″ measured at the first to ninth areas. The color reference value has a reference value in the X axis and a reference value in the Y axis according to the chromaticity coordinates. The color error values C11 to C33 of the first to ninth areas are calculated by comparing the reference values in the X axis and the Y axis with measured color values in the X axis and Y axis. In other words, values which subtract the measured values in X axis and Y axis from the reference values in the X axis and Y axis according to the chromaticity coordinates become the color error values C11 to C33.

For example, a case where the reference value in the X axis is 0.313 and the reference value in the Y axis is 0.329 will be described with reference to FIG. 6. If the measured values CI in the X and Y axes for a color displayed on the first area are 0.253 and 0.259, respectively, based on the chromaticity coordinates, an error value in the X axis at the first area is 0.06 obtained by subtracting 0.253 from 0.313 and the error value in the Y axis at the first area is 0.07 obtained by subtracting 0.259 from 0.329. Accordingly, the measured value (i.e. 0.253) in the X axis at the first area moves in the X axis direction by an error value of 0.06, and the measured value (i.e. 0.259) in the Y axis at the first area moves toward an origin point by 0.07, thus reaching a target value.

In other words, an equation which may obtain the color error value, such as color error values CI to CIII″, is as follows.

Δ error value in X axis=reference value in X axis−measured value in X axis

Δ error value in Y axis=reference value in Y axis−measured value in Y axis

Referring to the above equations, the color error values at the second to ninth areas CI′ to CIII″ as well as at the first area CI may be calculated. The measured values in the X and Y axes at each area are moved toward the origin point by the error value in the X coordinate in the X axis direction and the error value in the Y coordinate in the Y axis direction, respectively, thus obtaining a color correction coefficient for the first to ninth areas. The X and Y error values measured at the first to ninth areas indicate color error values C11 to C33. For example, the color error value (0.06, 0.07) measured at the first area corresponds to the first color coordinate value C11, and the color error value (0.0X, 0.0Y) measured at the second area corresponds to the second color coordinate value C12. In this way, the third area corresponds to the third coordinate value C13, the fourth area to the fourth coordinate value C21, the fifth area to the fifth coordinate value C22, the sixth area to the sixth coordinate value C23, the seventh area to the seventh coordinate value C31, the eighth area to the eighth coordinate value C32, and the ninth area to the ninth coordinate value C33.

In this way, the luminance error values P11 to P33 and the color error values C11 to C33 obtained at each area are supplied from the calculator 140 to the signal converter 150.

Referring back to FIG. 3A and FIG. 3B, the luminance error values P11 to P33 and the color error values C11 to C33 at the first to ninth areas supplied to the signal converter 150 are converted into the digital signals S11 to S33 at step S1500. The digital signals S11 to S33 corresponding to the first to ninth areas are supplied to the error memory 160 at step S1700.

Then, the plurality of synchronization signals inputted from the system main body 100 are processed in the image processor 170 in consideration of the digital signals S11 to S33 supplied to the error memory 160 at step S3000. The processed synchronization signals are supplied from the image processor 170 to the timing controller 110. The timing controller 110 generates the driving signals by using the processed synchronization signals supplied from the image processor 170 at step S5000. The driving signals are supplied to the LCD panel 112 through the data and gate drivers 106 and 108 at step S7000. Accordingly, the LCD panel 112 receiving signals considering the luminance and/or color at each area may display uniform luminance and/or color.

As described above, the exemplary LCD device and the exemplary method of driving the same according to the present invention calculate the error value by dividing the LCD panel into a plurality of areas, measuring the luminance and/or color, comparing the measured value with the reference value for the luminance and/or color, compensating the error values, and driving the LCD panel, thus improving display quality. Further, a process of testing the light source is removed, thus increasing work efficiency.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display device, comprising:
a liquid crystal display panel;
an memory which stores error values obtained by comparing measured values for characteristics of an image displayed on the liquid crystal display panel with a reference value suitable for the liquid crystal display panel;
an image processor which processes a signal supplied from a system main body in consideration of the error values;
a timing controller which receives the signal processed in the image processor and generates a driving signal; and
a driver which supplies the driving signal to the liquid crystal display panel.

2. The liquid crystal display device of claim 1, wherein the characteristics of the image include at least one of luminance and color of the image.

3. The liquid crystal display device of claim 2, further comprising a point light source which supplies light to the liquid crystal display panel.

4. The liquid crystal display device of claim 2, wherein the measured values are obtained by dividing the liquid crystal display panel into N areas in a row direction and M areas in a column direction and by measuring the characteristics of the image at each area.

5. The liquid crystal display device of claim 4, wherein the characteristics of the image include luminance, and the reference value of the luminance is an average value of the measured values of the luminance measured at each area.

6. The liquid crystal display device of claim 5, wherein the error values are values which subtract the reference value from the measured values that are higher than the reference value at each area, and
the image processor processes the signal supplied from the system main body so as to have a substantially same value as the reference value considering the error values with respect to areas having the measured values higher than the reference value.

7. The liquid crystal display device of claim 4, wherein the characteristics of the image include luminance, and the reference value of the luminance is a lowest value among the measured values of the luminance measured at each area.

8. The liquid crystal display device of claim 7, wherein the error values are values which subtract the reference value from the measured values at each area, and
the image processor processes the signal supplied from the system main body so as to have a substantially same value as the reference value considering the error values.

9. The liquid crystal display device of claim 4, wherein the characteristics of the image include color, and the reference value of the color is based on a chromaticity coordinates system.

10. The liquid crystal display device of claim 1, further comprising a measurer which measures the characteristics of the image displayed on the liquid crystal display panel.

11. The liquid crystal display device of claim 1, further comprising a calculator calculating the error values by comparing the measured values with the reference value.

12. A method for driving a liquid crystal display device, the method comprising:
storing an error value obtained by comparing measured values measuring characteristics of an image displayed on a liquid crystal display panel with a reference value in a memory;
processing a signal supplied from a system main body considering the error values supplied from the memory;
generating a driving signal by receiving the processed signal; and
supplying the driving signal to the liquid crystal display panel.

13. The method of claim 12, wherein the characteristics of the image include at least one of luminance and color of the image.

14. The method of claim 13, further comprising dividing the liquid crystal display panel into N areas in a row direction and M areas in a column direction and measuring the characteristic of the image at each area.

15. The method of claim 14, wherein the characteristics of the image include luminance, the error value is obtained by a difference between the measured values and the reference value, the reference value being a lowest luminance value among the measured values at each area.

16. The method of claim 14, wherein the characteristics of the image include luminance, the error value is obtained by a difference between the measured values of the luminance at each area and the reference value with respect to areas where the measured values are higher than the reference value, the reference value being an average value of the measured values of the luminance.

17. The method of claim 14, wherein the characteristics of the image include color, the error value for the color displayed at each area is obtained by subtracting a value in an X axis based on a chromaticity coordinates system from a reference value in the X axis and a value in a Y axis based on the chromaticity coordinates system from a reference value in the Y axis.

18. The method of claim 12, further comprising calculating the error value by comparing the measured values of the characteristics of the image displayed on the liquid crystal display panel with the reference value.

19. The method of claim 12, further comprising:
measuring the characteristics of the image displayed on areas of the liquid crystal display panel;
calculating the error value for the characteristics at each area;
converting the error value into a corresponding digital value; and
storing the converted digital value in the memory.

20. A method of improving uniformity of a liquid crystal display panel, the method comprising:
measuring characteristics of an image displayed on areas of the liquid crystal display panel;
calculating an error value for the characteristics at each area by comparing measured values with a reference value suitable for the liquid crystal display panel;
converting the error value into a corresponding digital value; and,
generating signals for the liquid crystal display panel in consideration of the error value.
